(19) United States
(12) Patent Application Publication
(10) Pub. No.: US 2019/0306744 A1
(43) Pub. Date: Oct. 3, 2019

(54) APPARATUSES AND METHODS FOR DETRMINING REFLECTIVE QUALITY OF SERVICE (RQOS) SUPPORT BY AN RQ TIMER

(71) Applicant: MEDIATEK INC., Hsin-Chu Ciry (TW)

(72) Inventors: Chien-Chun HUANG-FU, Hsin-Chu (TW); Chi-Hsien CHEN, Hsin-Chu (TW)

(21) Appl. No.: 16/362,998

(22) Filed: Mar. 25, 2019

Related U.S. Application Data
(60) Provisional application No. 62/649,474, filed on Mar. 28, 2018.

(51) Int. Cl. H04W 28/02; H04W 80/02; H04W 28/12; H04W 72/04; H04W 28/24

(52) U.S. Cl. CPC H04W 28/0268; H04W 80/02; H04W 28/24; H04W 72/042; H04W 28/12

(57) ABSTRACT

A User Equipment (UE) including a wireless transceiver and a controller is provided. The wireless transceiver performs wireless transmission and reception to and from a service network. The controller receives a response message of a Non-Access Stratum (NAS) procedure for establishing or modifying a Protocol Data Unit (PDU) session from the service network via the wireless transceiver, and determines that Reflective Quality of Service (RQoS) is not applied for the PDU session in response to the response message including an RQoS timer (RQ timer) value set to zero or deactivated.

### CROSS REFERENCE TO RELATED APPLICATIONS

This application claims priority of U.S. Provisional Application No. 62/649,474, filed on Mar. 28, 2018, the entirety of which is incorporated by reference herein.

### BACKGROUND OF THE APPLICATION

### Field of the Application

The application generally relates to the Reflective Quality of Service (RQoS) mechanism, and more particularly, to apparatuses and methods for determining RQoS support by an RQoS timer (RQ timer).

### Description of the Related Art

In a typical mobile communication environment, a User Equipment (UE) (also called Mobile Station (MS)), such as a mobile telephone (also known as a cellular or cell phone), or a tablet Personal Computer (PC) with wireless communications capability, may communicate voice and/or data signals with one or more service networks. The wireless communications between the UE and the service networks may be performed using various cellular technologies, including the Global System for Mobile communications (GSM) technology, the General Packet Radio Service (GPRS) technology, the Enhanced Data rates for Global Evolution (EDGE) technology, the Wideband Code Division Multiple Access (WCDMA) technology, the Code Division Multiple Access 2000 (CDMA-2000) technology, the Time Division-Synchronous Code Division Multiple Access (TD-SCDMA) technology, the Worldwide Interoperability for Microwave Access (WiMAX) technology, the Long Term Evolution (LTE) technology, the LTE-Advanced (LTE-A) technology, the Time Division LTE (TD-LTE) technology, the fifth-generation (5G) New Radio (NR) technology, and others.

According to the 3rd Generation Partnership Project (3GPP) specifications and/or requirements in compliance with the 5G NR technology, there is no clear indication from a 5G NR network to a UE to indicate whether the 5G NR network supports RQoS for a Protocol Data Unit (PDU) session during establishment or modification of the PDU session. The absence of such indication may cause the UE to keep monitoring and processing the RQoS parameters carried in the header of each downlink (DL) packet of the PDU session, even when the 5G NR network does not support RQoS for the PDU session. As a result, the UE's task of monitoring and processing the RQoS parameters for the PDU session which the 5G NR network does not support RQoS for will be in vain and cause extra power consumption.

### BRIEF SUMMARY OF THE APPLICATION

In order to solve the aforementioned problem, the present application proposes to use the RQ timer value carried in the response message of a PDU session establishment procedure or a PDU session modification procedure as a clear indication that whether the network side supports RQoS for the PDU session.

In a first aspect of the application, a User Equipment (UE) comprising a wireless transceiver and a controller is provided. The wireless transceiver is configured to perform wireless transmission and reception to and from a service network. The controller is configured to receive a response message of a Non-Access Stratum (NAS) procedure for establishing or modifying a Protocol Data Unit (PDU) session from the service network via the wireless transceiver, and determine that RQoS is not applied for the PDU session in response to the response message comprising an RQ timer value set to zero or deactivated.

In a second aspect of the application, a method for determining RQoS support by an RQ timer, executed by a UE communicatively connected to a service network, is provided. The method comprises the steps of: receiving a response message of a NAS procedure for establishing or modifying a PDU session from the service network; and determining that RQoS is not applied for the PDU session in response to the response message comprising an RQ timer value set to zero or deactivated.

Other aspects and features of the present application will become apparent to those with ordinarily skill in the art upon review of the following descriptions of specific embodiments of the UEs and the methods for determining RQoS support by an RQ timer.

### BRIEF DESCRIPTION OF DRAWINGS

The application can be more fully understood by reading the subsequent detailed description and examples with references made to the accompanying drawings, wherein:

FIG. 1 is a block diagram of a wireless communication environment according to an embodiment of the application;

FIG. 2 is a block diagram illustrating the UE 110 according to an embodiment of the application;

FIGS. 3A and 3B show a flow chart illustrating the method for determining RQoS support by an RQ timer according to an embodiment of the application;

FIG. 4 is a message sequence chart illustrating determination of RQoS support by an RQ timer according to an embodiment of the application; and

FIG. 5 is a message sequence chart illustrating determination of RQoS support by an RQ timer according to another embodiment of the application.

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

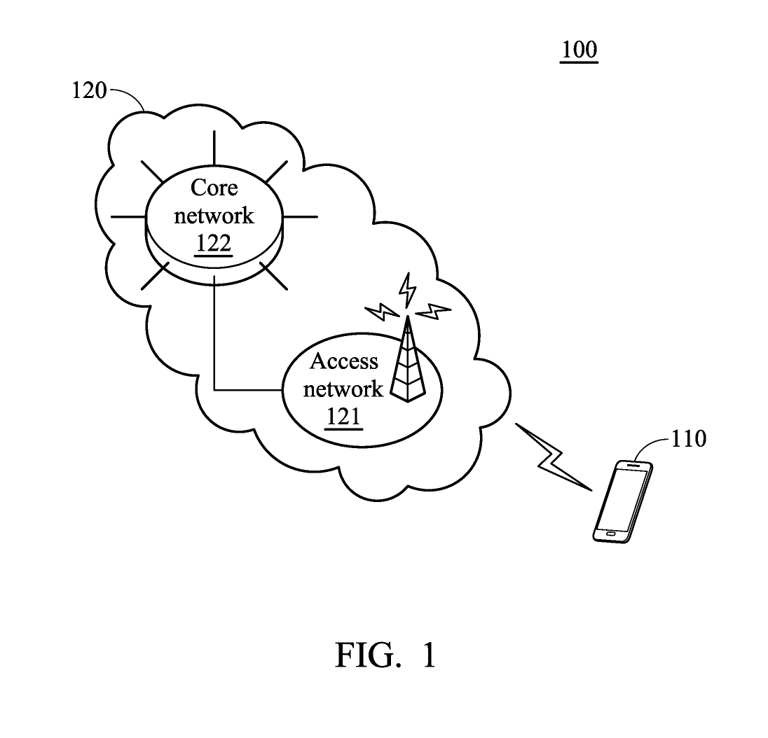

FIG. 1 is a block diagram of a wireless communication environment according to an embodiment of the application.

As shown in FIG. 1, the wireless communication environment 100 may include a User Equipment (UE) 110 and a service network 120, wherein the UE 110 may be wirelessly and communicatively connected to the service network 120 for obtaining mobile services.

The UE 110 may be a feature phone, a smartphone, a panel Personal Computer (PC), a laptop computer, or any wireless communication device supporting the cellular technology (e.g., the 5G NR technology) utilized by the service network 120. In another embodiment, the UE 110 may support more than one cellular technology. For example, the UE may support the 5G NR technology and a legacy 4G technology, such as the LTE/LTE-A/TD-LTE technology, or the WCDMA technology.

The service network 120 may include an access network 121 and a core network 122. The access network 121 is responsible for processing radio signals, terminating radio protocols, and connecting the UE 110 with the core network 122. The core network 122 is responsible for performing mobility management, network-side authentication, and interfaces with public/external networks (e.g., the Internet). The access network 121 and the core network 122 may each include one or more network nodes for carrying out said functions.

In one embodiment, the service network 120 may be a 5G NR network, and the access network 121 may be a Radio Access Network (RAN) and the core network 122 may be a Next Generation Core Network (NG-CN).

A RAN may include one or more cellular stations, such as next generation NodeBs (gNBs), which support high frequency bands (e.g., above 24 GHz), and each gNB may further include one or more Transmission Reception Points (TRPs), wherein each gNB or TRP may be referred to as a 5G cellular station. Some gNB functions may be distributed across different TRPs, while others may be centralized, leaving the flexibility and scope of specific deployments to fulfill the requirements for specific cases.

A 5G cellular station may form one or more cells with different Component Carriers (CCs) for providing mobile services to the UE 110. For example, the UE 110 may camp on one or more cells formed by one or more gNBs or TRPs, wherein the cells which the UE 110 is camped on may be referred to as serving cells, including a Primary cell (Pcell) and one or more Secondary cells (Scells).

A NG-CN generally consists of various network functions, including Access and Mobility Function (AMF), Session Management Function (SMF), Policy Control Function (PCF), Application Function (AF), Authentication Server Function (AUSF), User Plane Function (UPF), and User Data Management (UDM), wherein each network function may be implemented as a network element on a dedicated hardware, or as a software instance running on a dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs.

It should be understood that the wireless communication environment 100 described in the embodiment of FIG. 1 are for illustrative purposes only and are not intended to limit the scope of the application. For example, the wireless communication environment 100 may include both a 5G NR network and a legacy network (e.g., an LTE/LTE-A/TD-LTE network, or a WCDMA network), and the UE 110 may be wirelessly connected to one or both of the 5G NR network and the legacy network.

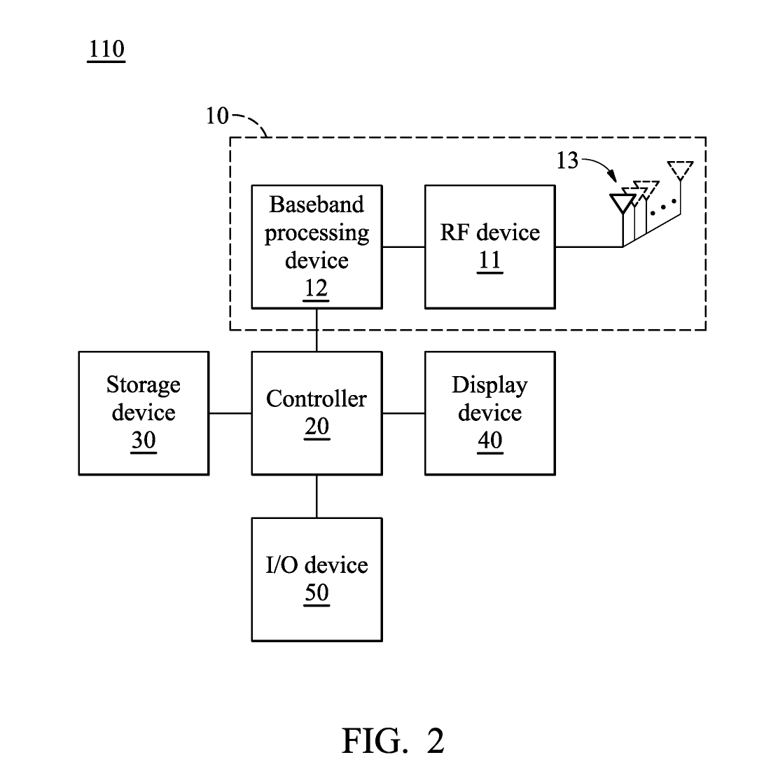

FIG. 2 is a block diagram illustrating the UE 110 according to an embodiment of the application.

As shown in FIG. 2, the UE 110 may include a wireless transceiver 10, a controller 20, a storage device 30, a display device 40, and an Input/Output (I/O) device 50.

The wireless transceiver 10 is configured to perform wireless transmission and reception to and from the cells formed by one or more cellular stations of the access network 121.

Specifically, the wireless transceiver 10 may include a Radio Frequency (RF) device 11, a baseband processing device 12, and antenna(s) 13, wherein the antenna(s) 13 may include one or more antennas for beamforming.

The baseband processing device 12 is configured to perform baseband signal processing and control the communications between subscriber identity card(s) (not shown) and the RF device 11. The baseband processing device 12 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 11 may receive RF wireless signals via the antenna(s) 13, convert the received RF wireless signals to baseband signals, which are processed by the baseband processing device 12, or receive baseband signals from the baseband processing device 12 and convert the received baseband signals to RF wireless signals, which are later transmitted via the antenna(s) 13. The RF device 11 may also contain multiple hardware devices to perform radio frequency conversion. For example, the RF device 11 may include a mixer to multiply the baseband signals with a carrier oscillated in the radio frequency of the supported cellular technologies, wherein the radio frequency may be any radio frequency (e.g., 30 GHz-300 GHz for mmWave) utilized in the 5G NR technology, or may be 900 MHz, 2100 MHz, or 2.6 GHz utilized in LTE/LTE-A/TD-LTE technology, or another radio frequency, depending on the cellular technology in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless communications with the service network 120, storing and retrieving data (e.g., program code) to and from the storage device 30, sending a series of frame data (e.g. representing text messages, graphics, images, etc.) to the display device 40, and receiving user inputs or outputting signals via the I/O device 50.

In particular, the controller 20 coordinates the aforementioned operations of the wireless transceiver 10, the storage device 30, the display device 40, and the I/O device 50 for performing the method for determining RQoS support by an RQ timer.

In another embodiment, the controller 20 may be incorporated into the baseband processing device 12, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a memory, such as a FLASH memory or a Non-Volatile Random Access Memory (NVRAM), or a magnetic storage device, such as a hard disk or a magnetic tape, or an optical disc, or any combination thereof for storing data (e.g., measurement configurations, DRX configurations, and/or measurement results), instructions, and/or program code of applications, communication protocols, and/or the method for determining RQoS support by an RQ timer.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 2 are for illustrative purposes only and are not intended to limit the scope of the application. For example, the UE 110 may include more components, such as a power supply, and/or a Global Positioning System (GPS) device, wherein the power supply may be a mobile/replaceable battery providing power to all the other components of the UE 110, and the GPS device may provide the location information of the UE 110 for use by some location-based services or applications. Alternatively, the UE 110 may include fewer components. For example, the UE 110 may not include the display device 40 and/or the I/O device 50.

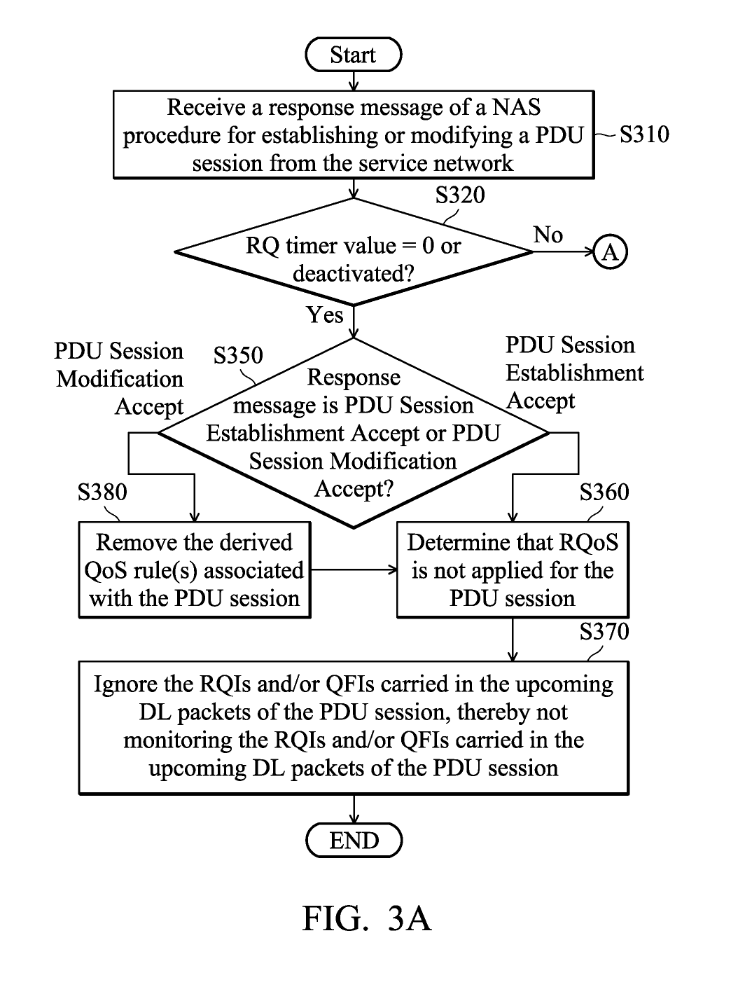

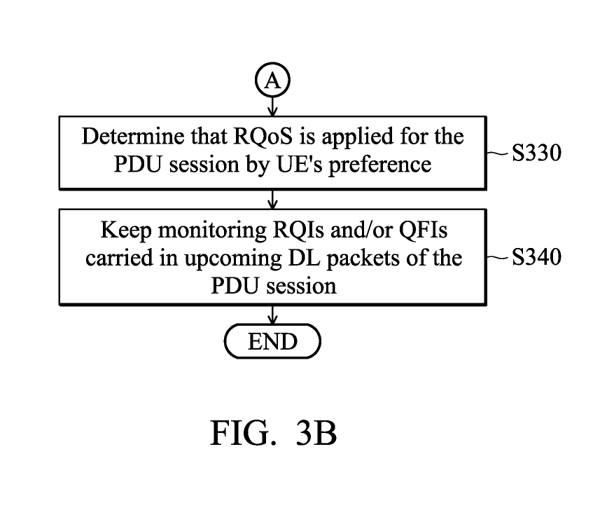

FIGS. 3A and 3B show a flow chart illustrating the method for determining RQoS support by an RQ timer according to an embodiment of the application.

In this embodiment, the method for determining RQoS support by an RQ timer is applied to and executed by a UE (e.g., the UE 110) communicatively connected to a service network (e.g., the service network 120).

To begin with, the UE receives a response message of a Non-Access Stratum (NAS) procedure for establishing or modifying a Protocol Data Unit (PDU) session from the service network (step S310).

In one embodiment, the NAS procedure may be a PDU session establishment procedure for a 5G system, and the response message may be a PDU Session Establishment Accept message, and prior to receiving the PDU Session Establishment Accept message, the UE may send a PDU Session Establishment Request message including an RQoS bit to the service network, wherein the RQoS bit is used to indicate whether the UE supports RQoS for the PDU session. The UE may determine whether or not to support RQoS for the PDU session according to the UE's preference (e.g., power concern).

In another embodiment, the NAS procedure may be a PDU session modification procedure for a 5G system, and the response message may be a PDU Session Modification Accept message. That is, prior to receiving the PDU Session Modification Accept message, the UE may send a PDU Session Modification Request message to revoke RQoS for the PDU session to the service network.

Next, the UE determines whether the response message includes an RQ timer value set to zero or deactivated (step S320).

If the response message includes an RQ timer value not set to zero nor deactivated, it basically means that the service network supports RQoS for the PDU session. In response to the response message including an RQ timer value not set to zero nor deactivated, the UE determines that RQoS is applied for the PDU session if it has decided to support RQoS for the PDU session when it previously initiated the establishment of the PDU session (step S330), and then keeps monitoring RQIs and/or QFIs carried in upcoming downlink (DL) packets of the PDU session in response to determining that RQoS is applied for the PDU session (step S340), and the method ends.

Specifically, when the RQ timer value included in the response message is not set to zero nor deactivated, it means that the service network supports RQoS for the PDU session.

By monitoring RQIs and/or QFIs carried in upcoming DL packets of the PDU session, it means that the UE needs to process the RQI field and/or the QFI field of the SDAP header of each DL packet. The RQIs and QFIs may be carried in the Service Data Adaptation Protocol (SDAP) headers of DL SDAP data PDUs. The detailed format of a DL SDAP data PDU with a SDAP header is illustrated below in table 1.

As shown in Table 1, the first octet of a DL SDAP data PDU is the SDAP header part which includes an RQI, a QFI, and RDI (RQoS flow to DRB (Data Radio Bearer) mapping Indication).

In response to the response message including an RQ timer value set to zero or deactivated, the UE determines whether the response message is a PDU Session Establishment Accept message or a PDU Session Modification Accept message (step S350).

If the response message is a PDU Session Establishment Accept message, the UE determines that RQoS is not applied for the PDU session (step S360). That is, the service network does not support RQoS for the PDU session.

Subsequent to step S360, the UE ignores the RQIs and/or QFIs carried in the upcoming DL packets of the PDU session, thereby not monitoring the RQIs and/or QFIs carried in the upcoming DL packets of the PDU session (step S370), and the method ends.

Subsequent to step S350, if the response message is a PDU Session Modification Accept message, the UE removes the derived QoS rule(s) associated with the PDU session (step S380), and the method proceeds to step S360.

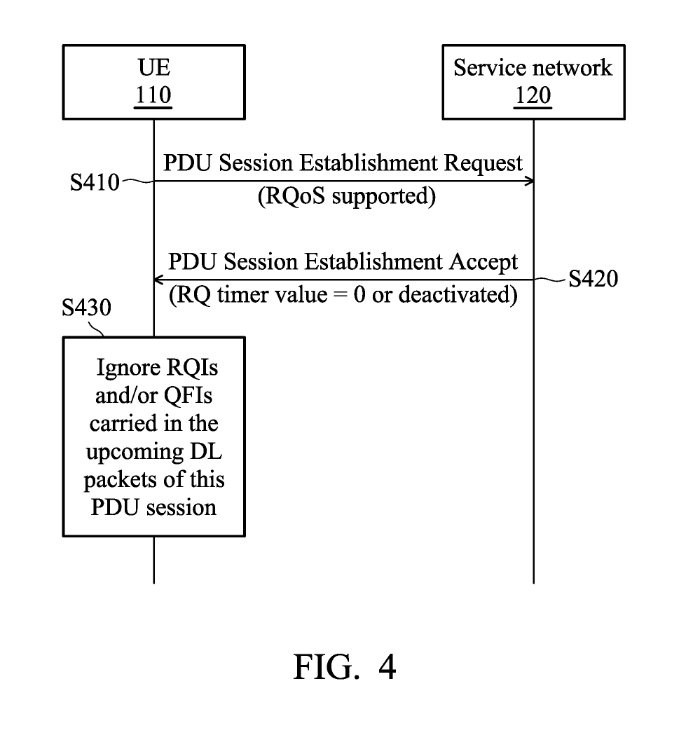

FIG. 4 is a message sequence chart illustrating determination of RQoS support by an RQ timer according to an embodiment of the application.

To begin with, the UE 110 initiates a PDU session establishment procedure by sending a PDU Session Establishment Request message to the service network 120 (step S410). Specifically, the PDU Session Establishment Request message may include a 5GSM capability Information Element (IE) in which an RQoS bit is used to indicate whether the UE supports RQoS or not. For example, when the RQoS bit is set to 0, it means that the UE does not support RQoS; when the RQoS bit is set to 1, it means that the UE supports RQoS. In this embodiment, the RQoS bit is set to 1 to indicate that the UE supports RQoS. The UE may determine whether or not to support RQoS for the PDU session according to the UE's preference (e.g., power concern).

Next, the UE 110 receives a PDU Session Establishment Accept message including an RQ timer value which is set to 0 or deactivated from the service network 120 (step S420). In this embodiment, when the RQ timer value is set to 0 or deactivated, it means that the service network 120 does not support RQoS for this PDU session.

In response to the PDU Session Establishment Accept message including an RQ timer value set to 0 or deactivated, the UE 110 considers that RQoS is not applied for this PDU session, and ignores the RQIs and/or QFIs carried in the upcoming DL packets of this PDU session (step S430). That is, by ignoring the RQIs and/or QFIs carried in the upcoming DL packets of this PDU session, the UE 110 does not need to monitor the RQIs and/or QFIs carried in the upcoming DL packets of the PDU session.

Please note that the detailed description regarding other contents of the PDU Session Establishment Request message and the PDU Session Establishment Accept message is omitted herein for brevity since it is beyond the scope of the present application, and reference may be made to the 3GPP TS 24.501 of release 15.

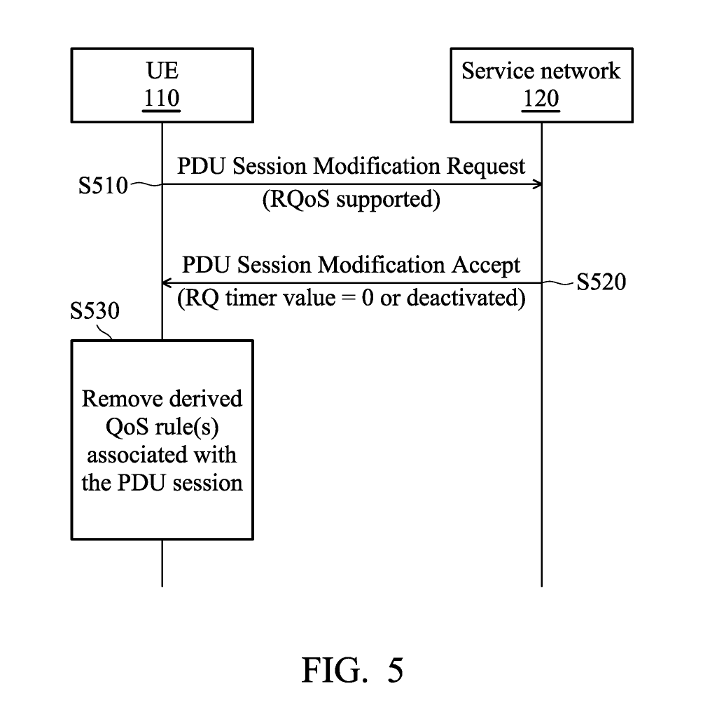

FIG. 5 is a message sequence chart illustrating determination of RQoS support by an RQ timer according to another embodiment of the application.

To begin with, the UE 110 initiates a PDU session modification procedure to revoke the previously indicated support of RQoS, by sending a PDU Session Modification Request message to the service network 120 (step S510). Specifically, the PDU Session Modification Request message may include a 5GSM capability IE in which an RQoS bit is set to 0 (i.e., “Reflective QoS not supported”) to indicate the request to revoke the usage of RQoS for this PDU session. In another embodiment, the UE 110 initiates a PDU session modification procedure to indicate its support of reflective QoS after the first inter-system change from S1 mode to N1 mode for a PDN connection established when in S1 mode.

Next, the UE 110 receives a PDU Session Modification Accept message including an RQ timer value which is set to 0 or deactivated from the service network 120 (step S520). In this embodiment, when the RQ timer value is set to 0 or deactivated, it means that the service network 120 accept the UE's request to revoke the usage of RQoS for this PDU session.

In response to the PDU Session Modification Accept message including an RQ timer value set to 0 or deactivated, the UE 110 removes the derived QoS rule(s) associated with the PDU session (step S530). That is, removing the derived QoS rule(s) associated with the PDU session refers to the fact that RQoS is not applied for the PDU session anymore and the UE 110 does not need to monitor the RQIs and/or QFIs carried in the upcoming DL packets of the PDU session.

Please note that the detailed description regarding other contents of the PDU Session Modification Request message and the PDU Session Modification Accept message is omitted herein for brevity since it is beyond the scope of the present application, and reference may be made to the 3GPP TS 24.501 of release 15.

In view of the forgoing embodiments, it should be appreciated that the present application solves the problem of the UE not knowing whether the network side supports RQoS for a PDU session, by using the RQ timer value carried in the response message of a PDU session establishment procedure or a PDU session modification procedure as a clear indication of such information. Advantageously, the unnecessary task of monitoring and processing the RQoS parameters for the PDU session which the network side does not support RQoS for may be eliminated from the UE, thereby saving UE's power consumption.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

What is claimed is:

1. A User Equipment (UE), comprising:
a wireless transceiver, configured to perform wireless transmission and reception to and from a service network; and
a controller, configured to receive a response message of a Non-Access Stratum (NAS) procedure for establishing or modifying a Protocol Data Unit (PDU) session from the service network via the wireless transceiver, and determine that Reflective Quality of Service (RQoS) is not applied for the PDU session in response to the response message comprising an RQoS timer (RQ timer) value set to zero or deactivated.

2. The UE of claim 1, wherein the controller is further configured to determine that RQoS is applied for the PDU session in response to the response message comprising an RQ timer value not set to zero nor deactivated, and keep monitoring Reflective QoS Indications (RQIs) carried in upcoming downlink (DL) packets of the PDU session in response to determining that RQoS is applied for the PDU session.

3. The UE of claim 1, wherein the controller is further configured to ignore RQIs carried in upcoming DL packets of the PDU session in response to determining that RQoS is not applied for the PDU session, thereby not monitoring the RQIs carried in the upcoming DL packets of the PDU session.

4. The UE of claim 1, wherein the controller is further configured to send a request message of a PDU session modification procedure to revoke RQoS for the PDU session to the service network via the wireless transceiver prior to receiving the response message, and remove one or more derived QoS rules associated with the PDU session in response to the response message being an accept message of the PDU session modification procedure and the response message comprising an RQ timer value set to zero or deactivated.

5. The UE of claim 1, wherein the controller is further configured to determine that RQoS is applied for the PDU session in response to the response message comprising an RQ timer value not set to zero nor deactivated, and keep monitoring QoS Flow Identifiers (QFIs) carried in upcoming DL packets of the PDU session in response to determining that RQoS is applied for the PDU session.

6. The UE of claim 1, wherein the controller is further configured to ignore QFIs carried in upcoming DL packets of the PDU session in response to determining that RQoS is not applied for the PDU session, thereby not monitoring the QFIs carried in the upcoming DL packets of the PDU session.

7. The UE of claim 1, wherein the response message is a PDU Session Establishment Accept message or a PDU Session Modification Accept message for a 5G system.

8. A method for determining Reflective Quality of Service (RQoS) support by an RQoS timer (RQ timer), executed by a UE communicatively connected to a service network, the method comprising:
receiving a response message of a Non-Access Stratum (NAS) procedure for establishing or modifying a Protocol Data Unit (PDU) session from the service network; and
determining that RQoS is not applied for the PDU session in response to the response message comprising an RQ timer value set to zero or deactivated.

9. The method of claim 8, further comprising:
determining that RQoS is applied for the PDU session in response to the response message comprising an RQ timer value not set to zero nor deactivated; and
keeping monitoring Reflective QoS Indications (RQIs) carried in upcoming downlink (DL) packets of the PDU session in response to determining that RQoS is applied for the PDU session.

10. The method of claim 8, further comprising:
ignoring RQIs carried in upcoming DL packets of the PDU session in response to determining that the RQoS is not applied for the PDU session, thereby not monitoring the RQIs carried in the upcoming DL packets of the PDU session.

11. The method of claim 8, further comprising:
sending a request message of a PDU session modification procedure to revoke RQoS for the PDU session to the service network prior to receiving the response message; and
removing one or more derived QoS rules associated with the PDU session in response to the response message being an accept message of the PDU session modification procedure and the response message comprising an RQ timer value set to zero or deactivated.

12. The method of claim 8, further comprising:
determining that RQoS is applied for the PDU session in response to the response message comprising an RQ timer value not set to zero nor deactivated; and
keeping monitoring QoS Flow Identifiers (QFIs) carried in upcoming DL packets of the PDU session in response to determining that RQoS is applied for the PDU session.

13. The method of claim 8, further comprising:
ignoring QFIs carried in upcoming DL packets of the PDU session in response to determining that RQoS is not applied for the PDU session, thereby not monitoring the QFIs carried in the upcoming DL packets of the PDU session.

14. The method of claim 8, wherein the response message is a PDU Session Establishment Accept message or a PDU Session Modification Accept message for a 5G system.
